(19) United States
(12) Patent Application Publication
(10) Pub. No.: US 2017/0252916 A1
(43) Pub. Date: Sep. 7, 2017

(54) Multibit Fastener Driver

(71) Applicant: Stanley Black & Decker, Inc., New Britain, CT (US)

(72) Inventors: Lucian Michael Guadagnoli, Trumbull, CT (US); Craig R. Steinfels, Powell, OH (US); Dustin Michael Lee, Worthington, OH (US); Dale E. Bauman, Columbus, OH (US); Thomas H. Courtemanche, Bristol, CT (US)

(73) Assignee: Stanley Black & Decker, Inc., New Britain, CT (US)

(21) Appl. No.: 15/059,233

(22) Filed: Mar. 2, 2016

(51) Int. Cl. B25G 1/08; B25G 1/10; B25B 15/04

(52) U.S. Cl. CPC B25G 1/085; B25B 15/04; B25G 1/102

(57) ABSTRACT

A hand tool which can be a multibit fastener driver with an in-handle bit storage system. A fastener driver which can have bit storage system which can have a bypass angle which provide an exit path for a bit being removed from storage which is free of intersection with obstacles and achieves efficient removal of bits from bit storage chambers. A bit storage system which can have one or more bit retainers and/or one or more bit grips which reversibly maintain a bit in storage when the fastener driver is in any orientation. Methods, means and processes for effective and efficient bit storage and release of bits for use by an operator.

### FIELD

This disclosure relates to multibit fastener drivers.

### BACKGROUND

Multibit hand tools suffer from a variety of difficult problems in design and operation. Bits are frequently lost by users and storing unused bits in the handle of a hand tool causes such tools to be unacceptably bulky, uncomfortable to use and require inefficient procedures to manage and change bits. In some designs, storage components which can be added to multibit hand tools result in unwieldy tools having poor balance and impractical overall dimensions. Additionally, the use of a tool handle to provide bit storage can fail to offer sufficient storage space for bits, exhibit poor bit retention resulting in bits falling out of storage, or alternatively can suffer from problems of failing to properly release bits from storage.

For ratcheting hand tools, the presence of a ratcheting mechanism complicates the storage of bits in, or attached, to a handle. The ratcheting mechanism is an obstruction which prevents access to, or release of, a bit from the ratchet end of the handle. Thus, the handle-based storage of bits for a ratcheting hand tool requires the operator to both insert and remove a bit from storage from the non-ratcheting end of the tool which is difficult, unwieldy and inefficient. For example, because the ratcheting mechanism obstructs the front of a ratcheting screwdriver, an operator can be forced to engage in a difficult and inconvenient process of inserting and removing a bit from storage in a handle solely from the end opposite of the ratchet mechanism, which can involve backing the stored bit out of the through hole, while managing a bit which is not stored, plucking and managing the newly released bit, and then storing the bit which was not previously in storage. It is difficult for an operator to manage a hand tool and an unstored bit, remove a stored bit by backing it out of the handle and then storing the unstored bit under normal conditions of operation. There is a strong need for improved bit storage for hand tools using multiple bits.

### SUMMARY

In some embodiments, a hand tool, such as a fastener driver, can have a handle body with a handle axis and a bit chamber which can have a bit chamber axis. The bit chamber axis and the handle axis can form a bypass angle which can have a value of greater than zero and less than 45°. In some embodiments, the bypass angle can provide a bypass clearance distance between a bit which is passing through a bit chamber outlet and a portion of a fastener driver front section. In further embodiments, the bit chamber can be adapted to store a first bit and can be configured such that the first bit moving out of storage from the bit chamber can move in the same general direction as a second bit moving into storage in the bit chamber. In yet additional embodiments, the bit chamber is adapted to have at least a portion of a bit grip.

In some embodiments, the hand tool can use a bypass angle which can have a value in a range of from 1° to 33°. In further embodiments, the bypass clearance distance can allow a bit which is passing through a bit chamber outlet to move past a ratchet mechanism without physical contact with the ratchet mechanism. In yet additional embodiments, the bypass angle can provide a handle clearance distance and/or a ratchet clearance distance.

In some embodiments, the hand tool can have a ratio of a bit chamber outlet radius to a bit chamber inlet radius which is greater than 1:1. In further embodiments, the bit chamber axis is not a constant distance from the handle axis along at least a portion of the bit chamber length. In yet additional embodiments, the hand tool can have a first bit chamber having a first bit chamber axis which is not parallel with the handle axis; and a second bit chamber having a second bit chamber axis which is not parallel with the handle axis.

In embodiments, the hand tool can have an exit path for a bit. In some embodiments, the exit path can have an exit path axis which is generally straight. In further embodiments, the exit path can have an exit path axis which is in part, or wholly, not straight. In yet additional embodiments, the exit path can have an exit path boundary configured to have a clearance distance from the handle body. In still further embodiments, the exit path can have an exit path boundary configured to have a clearance distance from a ratchet mechanism.

In some embodiments, the hand tool can have an exit chute.

In some embodiments, a fastening device can have a bit chamber having a bit grip which can have a bit channel. In further embodiments, the bit channel can have a first projection and a second projection which can be configured to receive at least a portion of a bit. The first projection can be configured for reversible contact with at least a portion of the bit when at least a portion of the bit is in the bit channel, and the second projection can be configured for reversible contact with at least a portion of the bit when at least a portion of the bit is in the bit channel. The bit grip can be adapted to reversibly retain and/or maintain a bit in a stored state.

In some embodiments, the bit grip can be configured at least in part in a bit chamber. In further embodiments, the fastening device can have a grip angle which is greater than zero degrees as measured between a first projection axis of the first projection and a second projection axis of the second projection. In further embodiments, the bit grip can have a polymer material and/or a magnet which can attract and/or magnetically affect a bit.

In some embodiments, a bit retainer can have at least one bit grip which can have a distal projection and a proximal projection, and in which at least a portion of the distal projection and at least a portion of the proximal projection can form at least a portion of a bit channel. The bit channel can be adapted to reversibly receive at least a portion of a bit in a bit chamber. The bit grip can be adapted to reversibly retain the bit in the bit chamber. In further embodiments, the bit retainer can have a number of the bit grips.

In some embodiments, the fastener driver can use a method of releasing a bit which can have the steps of: providing a fastener driver which can have a handle body and a rear end; providing a bit chamber in the handle body which can have a bit chamber inlet and a bit chamber outlet; providing a bypass angle which is greater than zero degrees (0°); providing a first bit in a stored state which can be reversibly stored in the bit chamber, the first bit having a first drive head proximate to the rear end, a first bit shank and a first bit tip; providing a second bit which can be in an unstored state, the second bit having a second bit drive head, a second bit shank and a second bit tip; contacting the first drive head of the first bit in a stored state with the second bit tip of the second bit in an unstored state; applying a motive force upon the first drive head by the second bit tip; causing by the motive force the first bit to move away from the rear end through the bit chamber outlet and into an unstored state; and moving the second bit through the bit chamber inlet and into a reversibly stored state.

In some embodiments, the method of releasing a bit can also have the steps of: providing an exit chute which can have at least a portion of the exit chute proximate to the bit chamber outlet; and moving at least a portion of the first bit adjacent to the portion of the exit chute proximate to the bit chamber outlet when the first bit is moved from a stored state into an unstored state.

In some embodiments, the method of releasing a bit can also have the step of providing the bypass angle to achieve a bypass clearance distance greater than zero mm (0 mm) when the first bit is moved from a stored state into an unstored state. In some embodiments, the method of releasing a bit can also have the step of providing the bypass angle to achieve a ratchet clearance distance and/or a handle clearance distance that is greater than zero mm (0 mm) when the first bit is moved from a stored state into an unstored state.

In some embodiments, the fastener driver can use a method for reversibly storing a bit, comprising the steps of: providing a fastening driver having one or more of a bit chamber; the bit chamber can be adapted to have a bit grip; the bit chamber and the bit grip can be adapted to receive at least a portion of a bit; moving the at least a portion of the bit into reversible contact with the grip; achieving a stored state of the bit in reversible contact with the grip; maintaining the bit in the stored state for a time greater than zero; moving the bit such that no contact exists between the bit grip and the bit; and achieving an unstored state of the bit when no contact exists between the bit grip and the bit.

In some embodiments, the method of reversibly storing a bit can also have the steps of: using a free bit in an unstored state to impart a motive force upon a portion of the bit in the stored state; and moving the bit in the stored state by the motive force such that no contact exists between the bit grip and the bit.

In some embodiments, the method of reversibly storing a bit can also have the steps of: using a free bit in an unstored state to impart a motive force upon a portion of the bit in the stored state; moving the bit in the stored state by the motive force such that no contact exists between the bit grip and the bit to achieve an unstored state of the bit; and moving the free bit into reversible contact with the bit grip achieving a stored state of the free bit.

In some embodiments, the method of reversibly storing a bit can also through a single motion achieves the steps of moving the free bit to impart a motive force upon the stored bit; moving the free bit into reversible contact with the bit grip, and achieving a stored state of the free bit. This single motion can change the state of the bit from stored to unstored, and also change the state of the free bit from unstored to stored.

### BRIEF DESCRIPTION OF THE DRAWINGS

This disclosure in its several aspects and embodiments solves the problems discussed above and significantly advances the technology of multibit fastener drivers. The present disclosure can become more fully understood from the detailed description and the accompanying drawings, wherein:

FIG. 1 shows an embodiment of a fastener driver;

FIG. 2 is a side view of the fastener driver showing a portion of a 1^{st} bit and a 2^{nd} bit;

FIG. 3 is a side view of the fastener driver showing a portion of a 3^{rd} bit and a 4^{th} bit;

FIG. 4 is a sectional view A-AA of the embodiment of FIG. 1 sectioned at a plane through the 1^{st} bit chamber axis and the 3^{rd} bit chamber axis;

FIG. 5 shows an exploded view of the handle;

FIG. 6 is a front view of the fastener driver showing an engaged bit;

FIG. 7 is a rear view of the fastener driver;

FIG. 8A shows a 1^{st} bit in a stored state and a free bit in an unstored state;

FIG. 8B shows the free bit being moved to impart a force upon the stored 1^{st} bit;

FIG. 8C shows the free bit being moved into a stored state while the previously stored 1^{st} bit is simultaneously released to an unstored state;

FIG. 8D shows the 1^{st} bit in an unstored state and the free bit in a stored state;

FIG. 9A is a front end perspective detail view of an embodiment of a 2^{nd} bit retainer;

FIG. 9B is a detail view of a 2^{nd} bit grip;

FIG. 9C is a detail view of a 3^{rd} bit grip;

FIG. 10 is a detail view of a bit chamber outlet showing a bit in a stored stated;

FIG. 11A shows a 4^{th} bit in a stored state and a free bit in an unstored state;

FIG. 11B shows the free bit being moved to impart a motive force upon the 4^{th} bit; and

FIG. 11C shows the 4^{th} bit released from the 4^{th} bit grip.

Herein, like reference numbers in one figure refer to like reference numbers in another figure.

### DETAILED DESCRIPTION

This disclosure relates to the many and varied embodiments of a multibit fastener driver and to methods for using the multibit fastener device, as well as for storing and using bits. The technology disclosed herein can be used in fastener drivers such as, but not limited to, ratcheting and non-ratcheting fastener drivers, hand tools having a driver bar and hand tools using a hand turned handle to drive a fastener, such as screwdrivers and nut drivers.

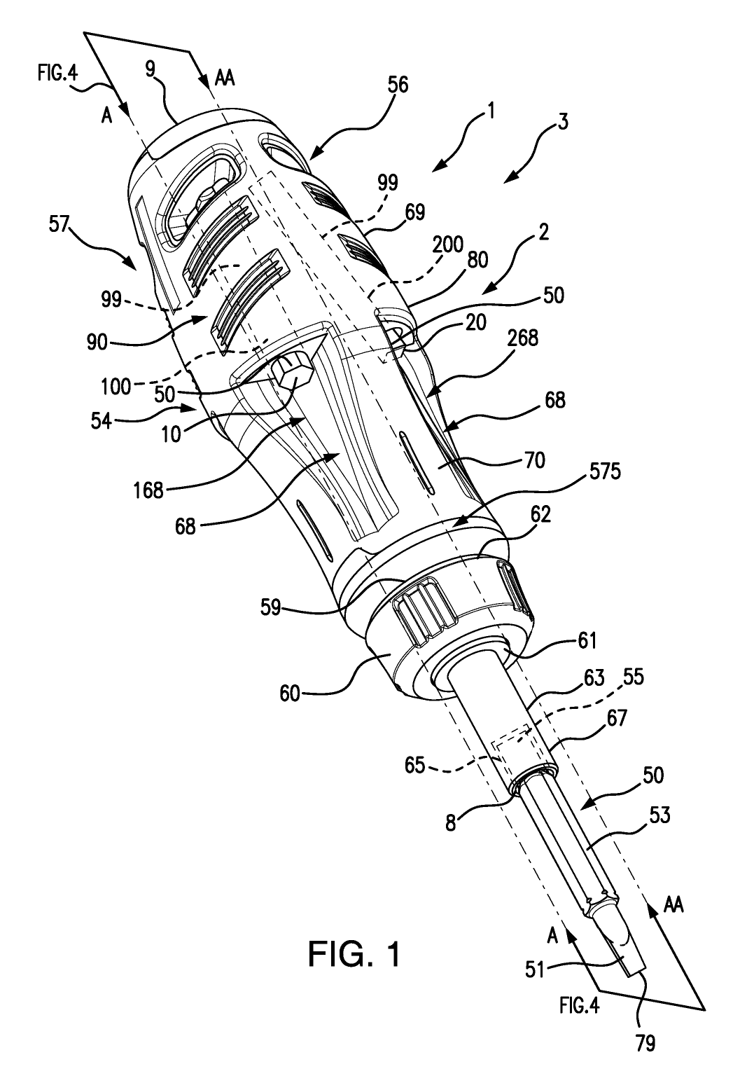

FIG. 1 shows an embodiment of a fastener driver 1 having a bit storage system 56 which ergonomically and efficiency stores one or more of a bit 50 in a handle 57. The fastener driver 1 can be a screwdriver 3, nut driver, or adapted to drive another type of fastener. The fastener driver 1 can be a ratcheting fastener driver 2, or of a non-ratcheting variety. The example of FIG. 1 is a ratcheting screwdriver 5 which can have a multibit design and the bit storage system 56 provided in a handle 57 which can have an ergonomically designed shape.

In some embodiments, the storage system can simultaneously store a number of bits 50. In non-limiting example, the number of the bits 50 stored simultaneously can range from 0-4 bits, or 1-4 bits, or 1-6 bits, or 1-8 bits, or 1-10 bits, or 1-12 bits, or greater. In an aspect, the storage system can be empty with zero (0) bits in storage, while optionally a bit 50 can be engaged with the driver bar 63.

The ratcheting screwdriver 2 can have a ratchet mechanism 60 which optionally can have a directional switch and multiple settings, such as settings to achieve a ratcheting clockwise, a ratcheting counterclockwise, as well as a locked setting in which no ratcheting can occur. The ratchet mechanism 60 can be coupled to and can drive a driver bar 63 which optionally can be removable or non-removable. Optionally, the driver bar 63 used can be selected from a variety of lengths and designs. The driver bar 63 can have a socket 65, which optionally can be a magnetic socket 67. The socket 65 can be configured to accept a wide variety of bits 50.

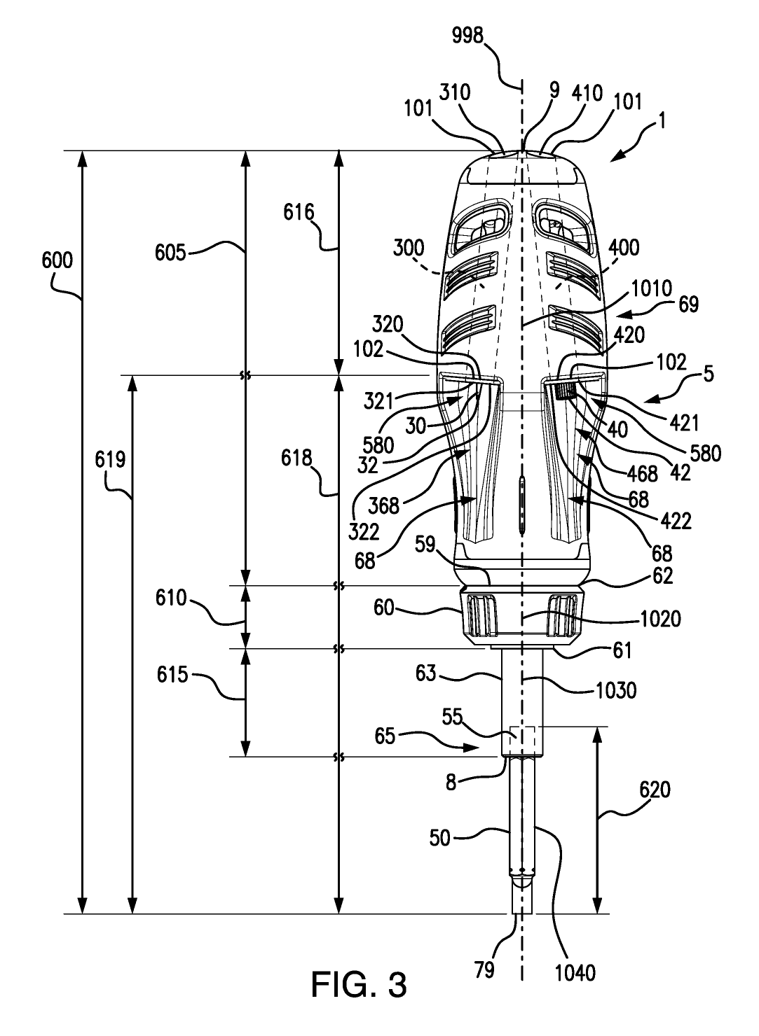

In an embodiment, an operator can select a bit 50 from a selection of one or more bits 50 of similar or different types which can be loose, or stored in the handle 57. An operator can store a number of bits, e.g. 1-4 bits, in the handle of the example embodiment of FIG. 1. FIG. 1 shows an embodiment which can have four (4) bits in storage, such as a 1^{st} bit 10, a 2^{nd} bit 20, a 3^{rd} bit 30 (FIG. 3) and a 4^{th} bit 40. The number of bits which are to be stored at a given time can be determined by the operator and can be chosen from a large number of bits.

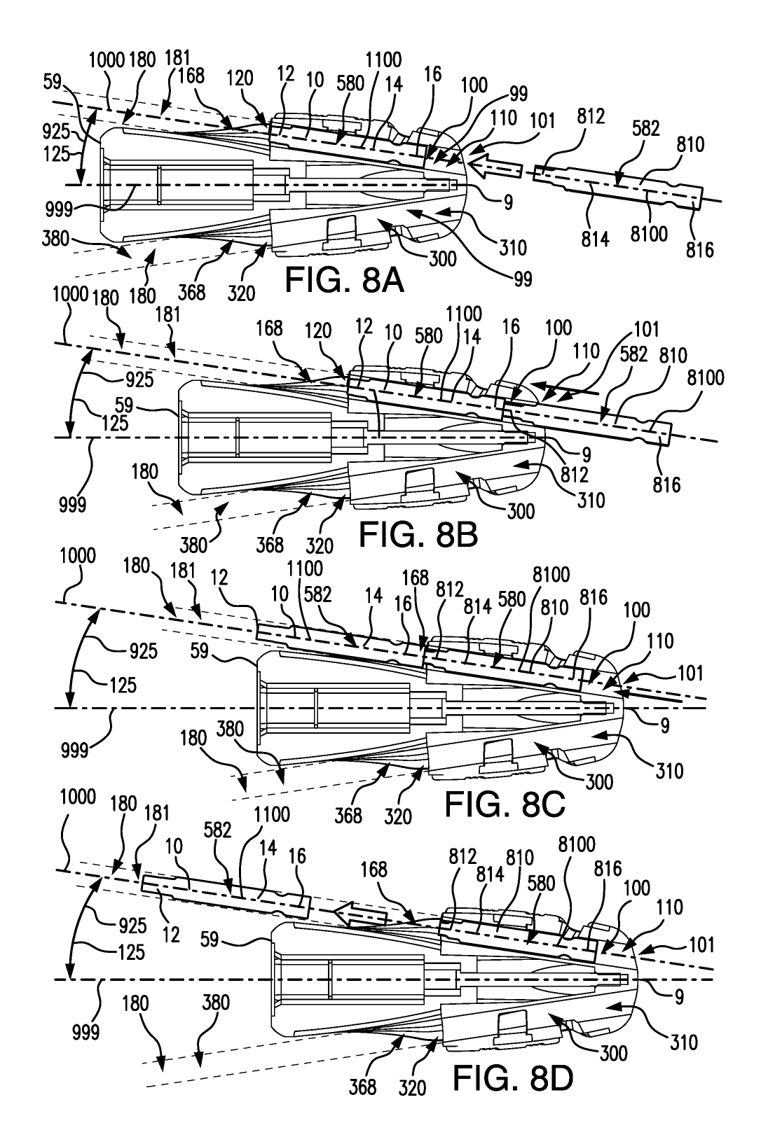

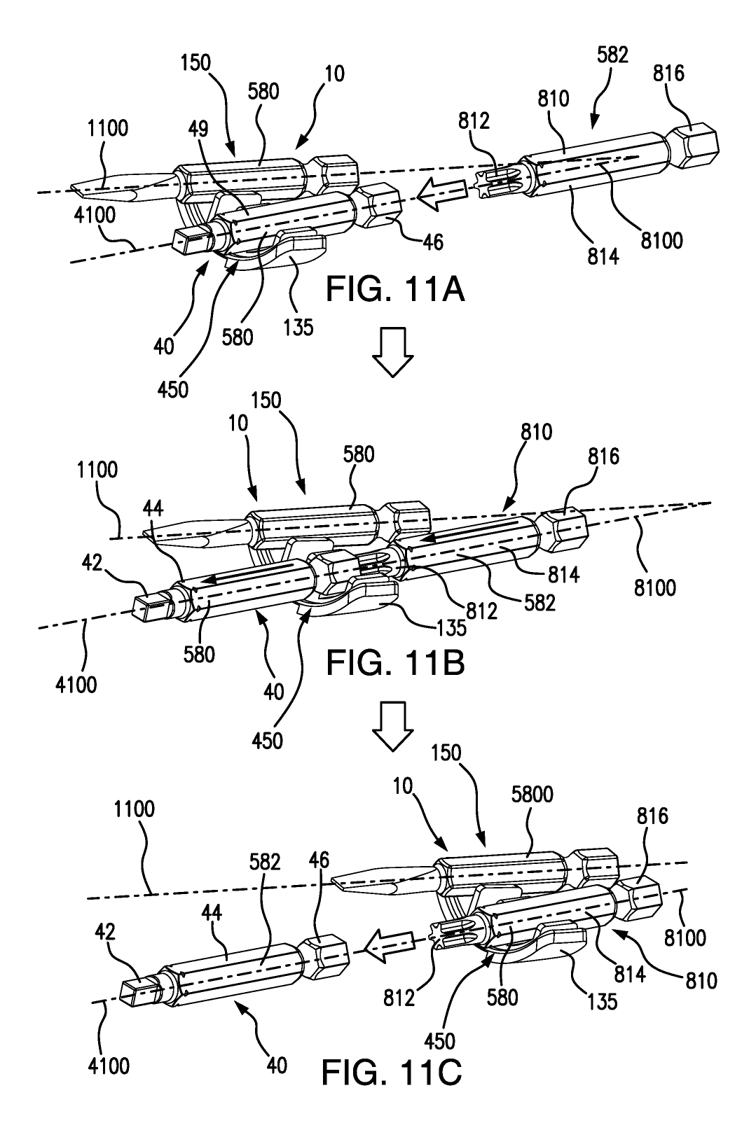

The embodiment of FIG. 1 allows the operator to store up to four of the bits 50 in the handle, as well as have one bit 50 engaged in the driver bar 63 for fastening a fastener. In some embodiments, the engaged bit 50 can be removed from the driver bar 63 and inserted into a bit chamber 99 which has a previously stored bit, the inserting freeing the previously stored bit and achieving the storage of the bit 50 itself in a single convenient motion (FIGS. 8A-8D and 11A-11C).

In some embodiments, the bit 50 can have the drive head 55, a bit shank 53 and a bit tip 51. This disclosure is not limited as to the type of bit 50, or bit tip 51, which can be used with the fastener driver 1 and bit storage technology disclosed herein. A broad variety of bit types, shank types, tip types and drive head types can be used. In the non-limiting example of FIG. 1, hex drive type bits having hex drive heads with a variety of tips are shown as can be used.

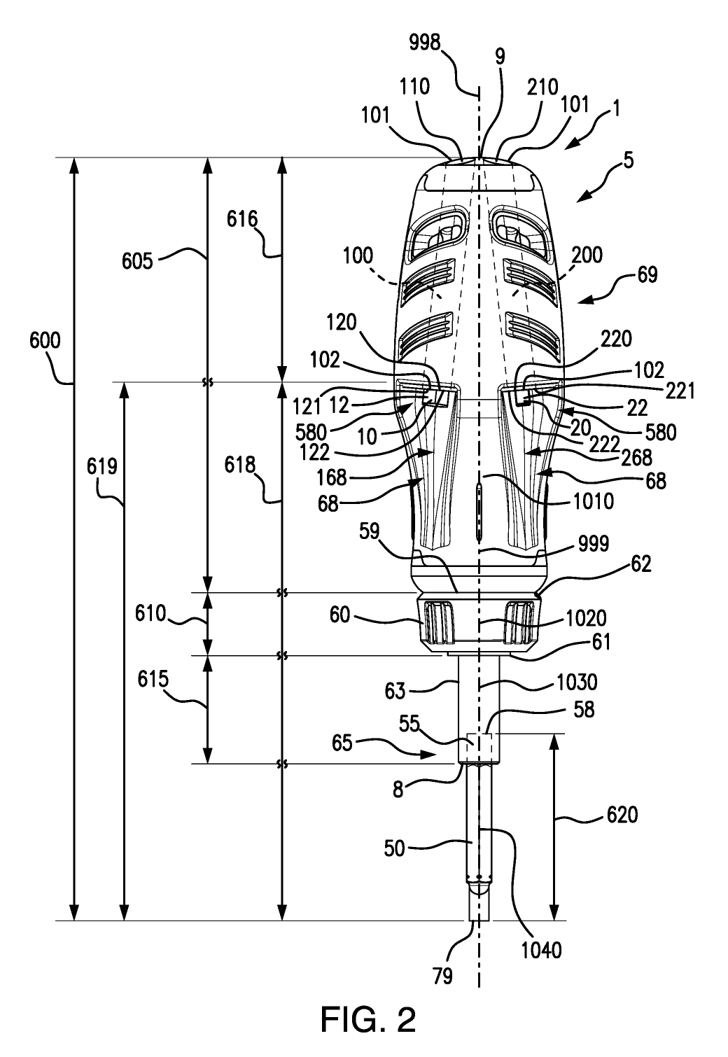

In some embodiments, the fastener driver 1 can be in non-limiting example be a screwdriver 3, a nut driver, or a hex driver, and can optionally have one or more bit storage chambers 99 that are non-parallel and not perpendicular to its primary axis, such as the longitudinal axis 998 (FIGS. 2, 3 and 4), which can be collinear with the driver centerline axis 999 (FIGS. 2, 3, 4, 5, 8A-8D and 9A-9C).

In some embodiments, a fastening driver can have single or multiple storage ports and/or bit chambers 99, in which the center of the bit chamber's entrance and center of the bit chamber's exit are unequal distances from the longitudinal axis 998 and/or driver centerline axis 999.

A broad variety of tip designs and configurations can be used. FIG. 1 shows the bit tip 51 which can be a flat drive head screwdriver type of bit. The multibit system 54 of the ratcheting fastening driver can use a number of bits, 1 . . . n, where n is large. The bits can be interchanged and fit into the socket 65. A number of the bits can be stored in handle 57 by using the bit storage system 56.

The geometry of the socket 65 and the type of bits 50 used with the ratcheting fastener driver 2 is not limited herein, such as hex six (6) point, or hex twelve (12) point sockets. In an embodiment, the socket can accept a hex drive head bit. However, a wide variety of socket and bit configurations can be used with the technology disclosed herein. FIG. 1 shows a hex socket, which can be a hex six (6) point socket, which can accept a bit 50 which can have a drive head 55 which can be a hex drive head, such as a hex six (6) point drive head.

Numeric values and ranges herein, unless otherwise stated, also are intended to have associated with them a tolerance and to account for variances of design and manufacturing, and/or operational and performance fluctuations. Thus, a number disclosed herein is intended to disclose values “about” that number. For example, a value X is also intended to be understood as “about X”. Likewise, a range of Y-Z, is also intended to be understood as within a range of from “about Y-about Z”. Unless otherwise stated, significant digits disclosed for a number are not intended to make the number an exact limiting value. Variance and tolerance, as well as operational or performance fluctuations, are an expected aspect of mechanical design and the numbers disclosed herein are intended to be construed to allow for such factors (in non-limiting e.g., ±10 percent of a given value). This disclosure is to be broadly construed. Likewise, the claims are to be broadly construed in their recitations of numbers and ranges.

The bits 50 disclosed herein can be in English measure, metric measure or otherwise. For example, in some embodiments, the bits 50 can be in English measure and can have bit sizes in a range of from 1/16 in to 1 in, or ⅛ in to ¾ in, or 3/16 in to 7/16 in, or ⅛ in to ½ in, such as 3/16 in, ¼ in, or 5/16 in. In some embodiments, the bits 50 can be of metric measure and can have bit sizes in a range of from 2 mm to 30 mm, or 3 mm to 25.4 mm, or 3 mm to 12.7 mm, or 4 mm to 8 mm, such as 3 mm, 6 mm, 8 mm, or 12 mm.

The bit length 620 (FIGS. 2 and 3) can be any length desired by a user. In some embodiments, the bit length 50 can be in a range of from 2 mm to 300 mm, or 15 mm to 100 mm, or 25 mm to 50 mm, such as 25.4 mm, 50.8 mm, 76.2 mm, or 100 mm. In some embodiments, the bit length 50 can be in a range of from 0.25 in to 12 in, or 0.5 in to 6 in, or 1 in to 4 in, or 2 in to 6 in, such as 1 in, 2 in, 3 in, 4 in, 5 in or 6 in.

In some embodiments which use a curved exit path, the curving and/or faceting of the curved exit path can be configured to accommodate one or more bit sizes. The smaller the bit, the smaller the radius of a curve portion, facet or section can be used.

The handle 57 embodiment of FIG. 1 can have a handle body 69, which optionally can have a handle grip 90. In an embodiment, the handle grip 90 can be overmolded onto the handle body 69. Optionally, the handle grip 90 can be of a unibody design with the handle body 69, or can have one or more pieces.

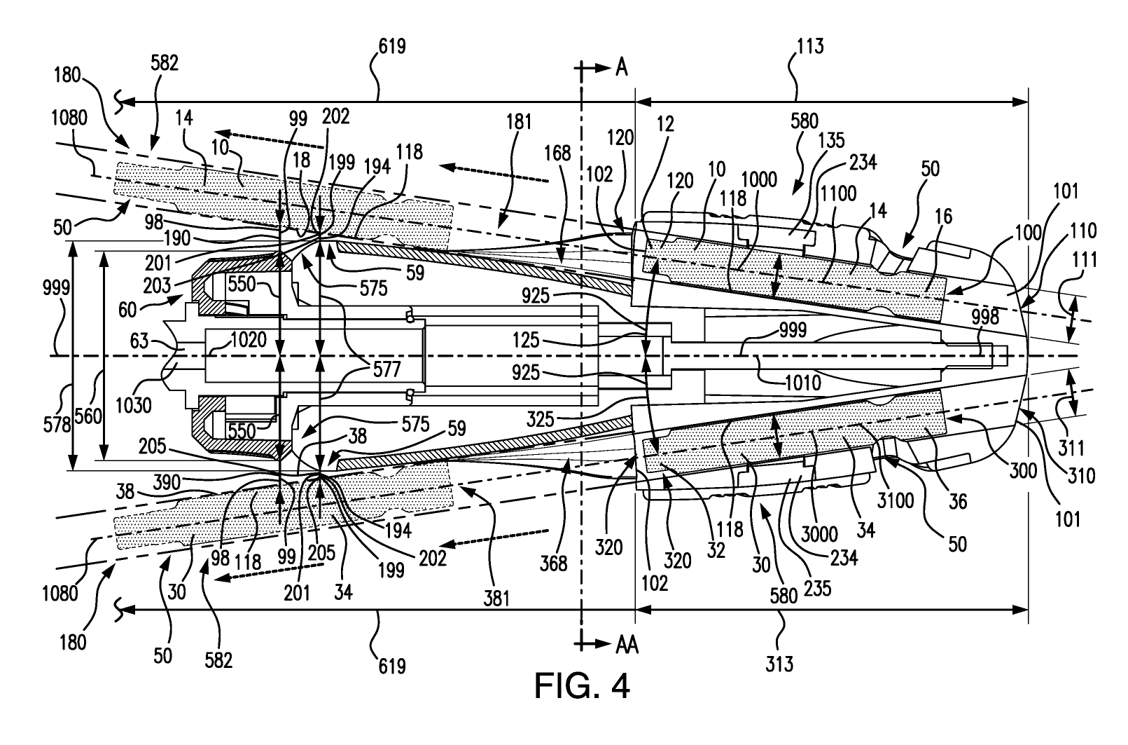

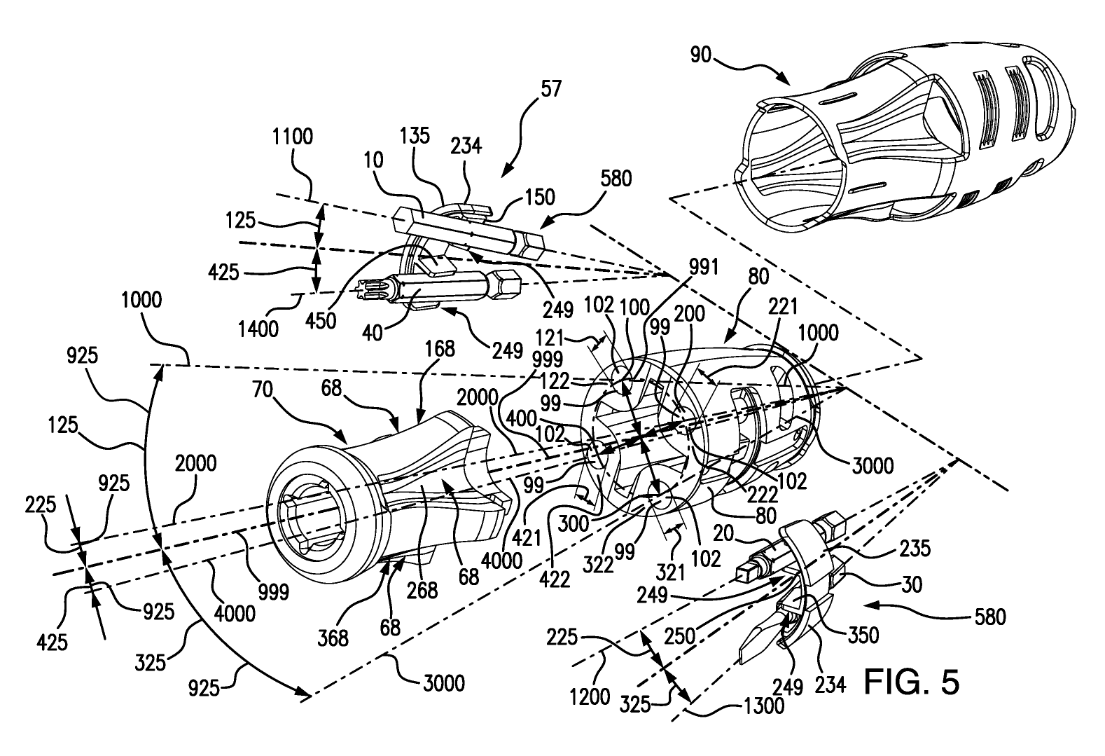

The handle grip 90 can be overmolded and can have an ergonomic feel, as well as optionally to deform as the bit retainer 234 (FIGS. 4 and 5) moves and/or changes shape, such as for non-limiting example when optionally the 1^{st} bit retainer 135, changes shape (FIGS. 4 and 5) when the bit 50 is inserted for storage. The overmolded material can be made from elastomeric or non-elastomeric materials, such as polypropylene and/or thermoplastic rubber. Additionally, when the bit retainer 234 changes shape the overmolded material of the handle grip 90 can provide a force against and/or to moderate the change in shape of the bit retainer which provide additional forces to maintain storage. The handle grip 90 can be made from elastomeric or non-elastomeric materials. In an embodiment, the handle grip 90 can be made at least in part, or wholly, from polypropylene and/or thermoplastic rubber.

The handle 57 can be used to store a number of the bits 50, e.g. 1 . . . n bits, in which n can be as large as the handle geometry will accommodate. For example, n can be from 1 to 10, or more, of the bits 50 which can be stored in the bit storage system 56 of the handle 57.

FIG. 1 shows an embodiment of the ratcheting fastener driver 2, which is the ratcheting screwdriver 5 which can use a multibit system 54 embodiment of the bit storage system 56. The bit storage system 56 of FIG. 1 can be configured to hold four (4) bits each respectively in a bit chamber 99.

In some embodiments, the bit chambers 99 are through holes in the handle 57 arranged in a revolver pattern, which can be a radial pattern, radially about the driver centerline axis 999 which can be collinear with a longitudinal axis 998 of the fastener driver 1. These through holes can be coordinated such that they are not parallel with the longitudinal axis 998 of the screwdriver, not parallel to the driver centerline axis 999, and can be arranged in the body in a revolver and/or radial pattern about the longitudinal axis 998 of the ratcheting screwdriver 5. In some embodiments, the through holes can be off-axis to the longitudinal axis 998, which can be collinear with the driver centerline axis 999.

In some embodiments, the fastener driver 1 can have a perpendicular distance, or other distance, between the bit and the longitudinal axis 998 which changes along the length of a bit and/or as the bit moves toward the front end of the fastener driver 1 as the bit is moved through and/or from bit storage, or a bit storage chamber.

FIG. 1 shows an embodiment in which the bit storage system 56 of the handle 57 has four (4) bit chambers 99 which respectively can reversibly store four (4) of the bits 50. A 1^{st} bit chamber 100 is shown storing a 1^{st} bit 10, and a 2^{nd} bit chamber 200 is shown storing a 2^{nd} bit 20. The perspective of FIG. 1 obscures, a 3^{rd} bit chamber 300 storing a 3^{rd} bit 30 (FIG. 3) and a 4^{th} bit chamber 400 storing a 4^{th} bit 40.

In some embodiments, the geometry of each of the bit chambers 99 and exit chutes 68, such as 1^{st} exit chute 168 and 2^{nd} exit chute 268, can be configured to allow each of the bits 50 to be removed from a bit chamber 99 free of obstruction or physical interference from the ratchet mechanism 60 or a handle front portion 575 (FIGS. 4 and 8). A sectional view of the embodiment of FIG. 1 taken along plane A-AA is provided in FIG. 4.

As shown in the example of FIG. 1, the handle 57 can extend from a rear end 9 to handle front end 59, which can be proximate to a rear ratchet end 62. The handle body 69 can have a rear handle body 80 and a front handle body 70. The front handle body 70 can be proximate to the ratchet mechanism 60 and can have a handle front portion 575 which can have the handle front end 59, a rear end 9 and a handle front end 59.

In some embodiments, the ratcheting screwdriver 5 which can have a ratchet mechanism 60. Optionally, the ratchet mechanism 60 can be configured proximate to the handle body 69. For example, the ratchet mechanism 60 can have a rear ratchet end 62 proximate to the handle front end 69. A front ratchet end 61 can provide an interface with the driver bar 63.

The driver bar 63 can have a front bar end 8 and a socket 65 which can accept the drive head 55 of a bit 50. FIG. 1 shows a bit 50 engaged by the drive head 55 with the driver bar 63. In some embodiments, when the bit 50 is engaged by the socket 65, the bit 50 can be turned by means of an operator's hand turning of the fastener driver 1 to drive a fastener into a workpiece. The ratcheting screwdriver 5 can have a front end 79.

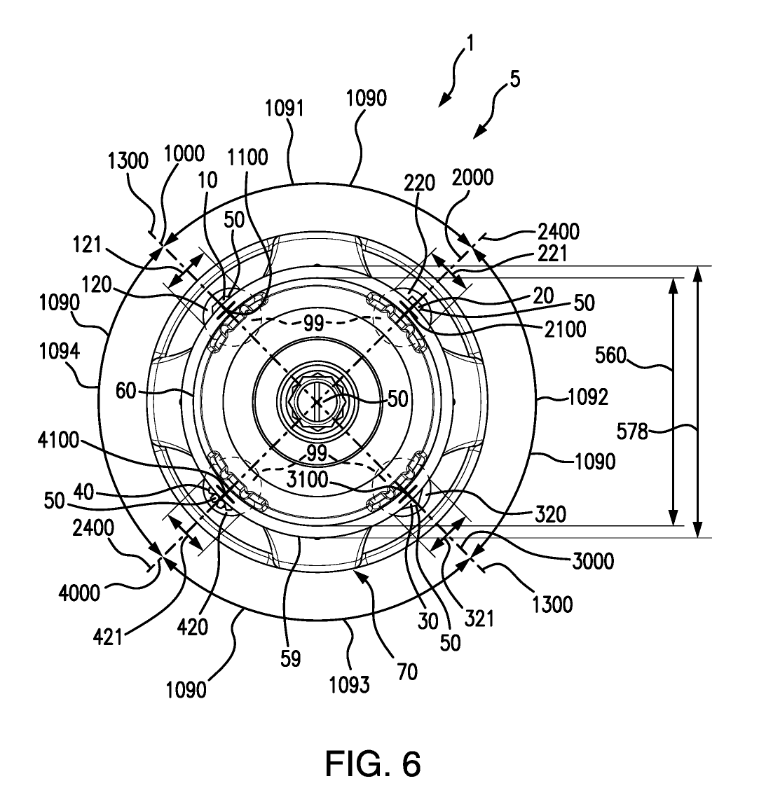

FIG. 2 is a side view of the fastener driver 1 showing the 1^{st} bit 10 and the 2^{nd} bit 20. The embodiment of FIG. 2 shows the 1^{st} bit 10 in a stored state 580 in the 1^{st} bit chamber 100, with a portion of the 1^{st} bit tip 12 protruding from the 1^{st} bit chamber outlet 120. The 1^{st} bit chamber outlet 120 can have a 1^{st} bit chamber outlet diameter 121 (FIG. 6). The 1^{st} bit chamber 100 is shown by dashed lines and can be a through hole in the handle body 69. Optionally, a 1^{st} exit chute 168 can be provided for ease of removal of 1^{st} bit 10 from the 1^{st} bit chamber 100 to achieve an unstored state 582 (FIG. 8C) of 1^{st} bit 10. A bit 50 can be inserted into the 1^{st} bit chamber 100 though the 1^{st} chamber inlet 110.

FIG. 2 also shows the 2^{nd} bit 20 in a stored state 580 in the 2nd bit chamber 200, with a portion of the 2^{nd} bit tip 22 protruding from the 2^{nd} bit chamber outlet 220. The 2^{nd} bit chamber outlet 220 can have a 2^{nd} bit chamber outlet diameter 221 (FIG. 6). The 2^{nd} bit chamber 200 is shown by dashed lines and can be a through hole in the handle body 69. Optionally, a 2^{nd} exit chute 268 can be provided for ease of removal of 2^{nd} bit 20 from the 2^{nd} bit chamber 200 to achieve an unstored state 582 of 2^{nd} bit 20. A bit 50 can be inserted into the 2^{nd} bit chamber 200 though the 2nd chamber inlet 210.

In some embodiments, the bit chamber inlet 101 can have a different diameter than the bit chamber outlet 102.

FIG. 2 shows a number of dimensions of the example embodiment of the fastener driver 1 shown in FIG. 1, which can be the ratcheting screwdriver 5, as shown.

In an embodiment, the overall fastener driver length 600 can be measured from the rear end 9 to the front end 79. The overall fastener driver length 600 can have a value in non-limiting example of 50 mm or greater, or 150 mm or greater. In some embodiments, the overall fastener driver length 600 can have a value in the range of from 50 mm to 600 mm, or 100 to 300 mm, or 150 mm to 250 mm, or 150 mm to 200 mm, such as 100 mm, 150 mm, 190 mm, 300 mm, or 400 mm. In some embodiments for non-limiting example, the overall fastener driver length 600, with an engaged bit, can be 174 mm, or 154 mm.

The handle length 605 can be measured from the rear end 9 to the front handle end 59. The handle length 605 can in non-limiting example have a value of 50 mm or greater, or 150 mm or greater. In some embodiments, the handle length 605 can have a value in the range of from 50 mm to 300 mm, or 75 to 200 mm, or 50 mm to 150 mm, or 50 mm to 130 mm, such as 100 mm, 110 mm, or 120 mm. In an embodiment, the handle length 605 can be 110.5 mm.

The ratcheting mechanism length 610 of the ratchet mechanism 60 can be measured from the rear ratchet end 62 to the front ratchet end 61. The ratcheting mechanism length 610 can have a value in non-limiting example of 3 mm or greater, or 10 mm or greater, or 20 mm, or 40 mm, or greater. In some embodiments, the ratcheting mechanism length 610 can have a value in the range of from 3 mm to 50 mm, or 5 to 30 mm, or 5 mm to 25 mm, or 8 to 15 mm, such as 8 mm, or 10 mm, or 12 mm, or 15 mm.

The driver bar length 615 of the driver bar 63 can be measured from the front ratchet end 61 to the front bar end 8. The driver bar length 615 can have a value in non-limiting example of 5 mm or greater, or 50 mm or greater, or 600 mm, or greater. In some embodiments, the driver bar length 615 can have a value in the range of from 3 mm to 600 mm, or 5 to 30 mm, or 10 mm to 50 mm, or 15 to 75 mm, such as 15 mm, or 25 mm, or 30 mm, or 50 mm. In some embodiments, the handle can receive interchangeable driver bars of a variety of lengths and for driving a variety of different types of fasteners. In some embodiments, the driver bar can be a bolstered driver bar which can have a portion adapted to allow a torque enhancement device, such as a wrench and/or adjustable wrench to engage the driver bar and exert additional torque in addition to that provided by an operator's hand turning the handle.

The bit length 620 can be measured from the rear bit end 58 to the front end 79. The bit length 620 can have in non-limiting example a value of 5 mm or greater, or 50 mm or greater, or 200 mm or greater. In some embodiments, the bit length 620 can have a value in the range of from 3 mm to 200 mm, or 5 to 100 mm, or 10 mm to 75 mm, or 15 to 60 mm, such as 15 mm, or 25 mm, or 30 mm, or 50 mm.

Optionally, in some embodiments, the handle 57 can have a rear handle body length 616 and a front handle body length 618. The rear handle body length 616 can in non-limiting example be measured from the rear end 9 to a bit chamber outlet 102, such as the 1^{st} bit chamber outlet 120 which can optionally be surrounded by outlet face 122 and/or the 2^{nd} bit chamber outlet 220 which can optionally be surrounded by outlet face 222. The rear handle body length 616 can have a value of 30 mm or greater, or 50 mm or greater. In some embodiments, the rear handle body length 616 can have a value in the range of from 20 mm to 100 mm, or 25 mm to 75 mm, or 25 mm to 50 mm, such as 50 mm, or 55 mm, or 60 mm, or 70 mm, or 80 mm.

The front handle body length 618 can be measured from the bit chamber outlet 102, such as the 1^{st} bit chamber outlet 120 and/or the 2^{nd} bit chamber outlet 220 to the handle front end 59. The front handle body length 618 can in non-limiting example have a value of 30 mm or greater, or 50 mm or greater. In some embodiments, the front handle body length 618 can have a value in the range of from 20 mm to 150 mm, or 25 mm to 100 mm, or 35 mm to 75 mm, such as 40 mm, or 50 mm, or 60 mm, or 70 mm, or 80 mm.

FIG. 2 also shows a fastener driver front section 619 which in embodiments can encompass the parts and pieces of the fastener driver 1 which are located between the bit chamber outlet 102 and the front end 79 as arranged along the longitudinal axis. The fastener driver front section 619 in the embodiment of FIG. 2 encompasses the front handle body, the handle front portion 575 (FIG. 4), the ratchet mechanism 60, the driver bar and the bit 50. The length of the fastener driver front section 619 can be the sum of the parts of which it is composed.

When the bit 50 is removed from storage in a bit chamber 99, the bit 50 can move past at least a part of fastener driver front section 619. The bypass angle 925 (FIG. 4) can provide a bypass clearance distance 199 between a portion of the bit 50 exiting said bit chamber and a portion of a fastener driver front section 619, such as between the bit 50 and the handle front portion and/or between the bit 50 and the ratcheting mechanism 60.

FIG. 3 is a side view of the example fastener driver of FIG. 1 showing the 3rd bit 30 and the 4th bit 40. The embodiment of FIG. 2 shows the 3rd bit 30 in a stored state 580 in the 3rd bit chamber 300, with a portion of the 3rd bit tip 32 protruding from the 3rd chamber outlet 320 which can have a 3^{rd} bit chamber diameter 321 (FIG. 6) and which can optionally be surrounded by outlet face 322. The 3rd bit chamber 300 is shown by dashed lines and can be a through hole in the handle body 69. Optionally, a 3rd exit chute 368 can be provided for ease of removal of 3rd bit 30 from the 3rd bit chamber 300 to achieve an unstored state 582 of 3rd bit 30. A bit 50 can be inserted into the 3rd bit chamber 300 though the 3rd chamber inlet 310.

FIG. 3 also shows the 4th bit 40 in a stored state 580 in the 4th bit chamber 400, with a portion of the 4th bit tip 42 protruding from the 4th chamber outlet 420 (FIG. 6) which can optionally be surrounded by outlet face 422. The 4th bit chamber 400 is shown by dashed lines and can be a through hole in the handle body 69. Optionally, a 4th exit chute 468 can be provided for ease of removal of 4^{th} bit 40 from the 4^{th} bit chamber 400 to achieve an unstored state 582 of 4^{th} bit 40. A bit 50 can be inserted into the 4^{th} bit chamber 400 though the 4th chamber inlet 410.

The rear handle body length 616 can be measured from the rear end 9 to a bit chamber outlet 102, such as the 3^{rd} bit chamber outlet 320 and/or the 4^{th} bit chamber outlet 420. The front handle body length 618 can be measured from the bit chamber outlet 102, such as the 3^{rd} bit chamber outlet 320 and/or the 4^{th} bit chamber outlet 420 to the handle front end 59.

FIG. 3 also shows the fastener driver front section 619.

Like dimensions in FIG. 2 and FIG. 3 have like values.

FIG. 4 is a sectional view A-AA of the example embodiment of FIG. 1 taken coplanar through the 1^{st} bit chamber axis 1000 and the 3^{rd} bit chamber axis 3000.

FIG. 4 shows the 1st bit chamber 100 in which 1⁴ bit 10 can be stored. In the embodiment of FIG. 4, the 1st bit chamber 100 can have a 1st bit chamber axis 1000, a 1^{st} bit chamber inlet 110, a 1^{st} bit chamber inlet diameter 111, a 1^{st} bit chamber length 113 and a 1^{st} bit chamber outlet 120. A diameter of a bit chamber optionally can be the same or different from the bit chamber inlet diameter and/or outlet diameter. The bit chamber can have a continuous diameter along its length, or it can have different diameters used along its length, as we well as can accommodate at least a portion of one or more or a bit retainer or at least a portion of one or more of a bit grip.

FIG. 4 shows the 1st bit chamber 100 storing the 1^{st} bit 10 which can have a 1^{st} bit tip 12, a 1^{st} bit shank 14 and a 1^{st} drive head 16. A 1^{st} bit axis 1100 can be collinear with the 1st bit chamber axis 1000.

FIG. 4 also shows driver centerline axis 999, which can be collinear with longitudinal axis 998, which and extends along a fastener driver length 600 (FIGS. 2 and 3), and which can be collinear with each of the handle axis 1010, the ratchet mechanism axis 1020, the driver bar axis 1030 and the bit axis 1040 (FIG. 2).

The ratchet mechanism 60 can have a maximum ratchet radius 550, which can be measured perpendicular to the driver centerline axis 999 and/or the ratchet mechanism axis 1020. A maximum ratchet diameter 560 is also shown.

FIG. 4 illustrates the single motion removal step of the 1^{st} bit 10 from a stored state 580 as shown in solid lines in FIG. 4 an unstored state 582 to a removed state, as shown in dashed lines in FIG. 4. The single motion removal step moves the 1^{st} bit 10 along an exit path 180, such as 1^{st} exit path 181, along the first exit chute 168 and clear of the 1^{st} bit chamber 100 and the handle 57 for use by the operator. In an embodiment, the exit path 180 can have an exit path centerline axis 1080 which is collinear with the 1⁴ bit chamber axis 1000 and the 1⁴ bit axis 1100.

In some embodiments, the fastener driver 1, such as a ratcheting fastener driver 2, can have bit chamber 99 which can be through holes which can be angled away from the longitudinal axis 998 such that the bit does not travel parallel to the longitudinal axis 998 of the fastener driver 1 when placed in or removed from storage, which can avoid the bit 50 being obstructed during removal from the bit chamber 99 by features of the front end of the fastening driver 1, such as the ratchet mechanism 60, the handle front portion 575, or other features.

Using a bypass angle 925 allows the use of the ratchet mechanism 60 at a location proximate to the handle front portion 575 without obstructing the exit path 180. For example, the bypass angle 925 achieves an exit path 180 for a bit 50 which is not obstructed by the ratchet mechanism and achieves a one-step storage and/or release functionality, or single motion storage and/or release functionality, for a bit 50. For example, 1^{st} bypass angle 125 achieves a 1^{st} exit path 181 for a 1^{st} bit 10. Thus, a single action, or single motion, push and pick capability is achieved in the hand tool of FIG. 4 having a ratcheting mechanism.

The use of a bypass angle 925 avoids the need to use an impractically large handle to bypass an obstruction to the removal of a bit 50 when removed from a stored state 582 by a motion in a direction from the rear end 9 toward the front driver end 8.

The bypass angle 925 can range from zero degrees (0°) to 90° from the driver centerline axis. In an embodiment, the bypass angle, such as in non-limiting example, the 1^{st} bypass angle 125 and/or the 3^{rd} bypass angle 325, can have a value in a range of 0° to 90°, or 33° to 66°, or 0° to 33°, 15° to 33°, or 0° to 15°, or 5° to 10°, or 3° to 8°, or 2° to 5°, or 1° to 3°, such as 1°, or 2°, or 3°, or 4°, or 5°, or 8°, or 10°.

In the embodiment of FIG. 4, the 1^{st} bit chamber 100 can have a first bit chamber axis 1000 which can be at an angle with the driver centerline axis 999 and forming a bypass angle 925. The bypass angle 925 can be measured as the angle from the driver centerline axis 999 to the 1^{st} bit chamber axis 1000. As shown in FIG. 4, the 1^{st} bit axis 1100 can be collinear with the 1^{st} bit chamber axis 1000 and the bypass angle 925 in this embodiment can also be equal to the angle measured from the driver centerline axis 999 to the 1^{st} bit axis 1100.

The embodiment of FIG. 4 shows two types of bypass clearance distances 199. A handle bypass clearance 201 can be the handle clearance distance 202 between the maximum handle front end radius 577 and the proximate surface 118 of the bit 50, such as for non-limiting example 1^{st} bit 10, or 3^{rd} bit 30. In some embodiments, the handle clearance distance 202 can be in a range of 0.5 mm to 20 mm, or 1 mm to 10 mm, or 1 mm to 5 mm, such as 1.4 mm, 1.5 mm, 1.9 mm, 2 mm, 5 mm, or 10 mm. Each of the 1^{st} handle clearance distance 203, 2^{nd} handle clearance distance 204 (not shown), 3^{rd} handle clearance distance 205, and 4^{th} handle clearance distance 206 (not shown), can respectively have a value in a range of 0.5 mm to 20 mm, or 1 mm to 10 mm, or 1 mm to 5 mm, such as 1.4 mm, 1.5 mm, 1.9 mm, 2 mm, 5 mm, or 10 mm. Each of the respective handle clearance distances can be the same or different.

The bypass angle 925 achieves a configuration which provides a bypass clearance distance 199 is the clearance distance by which the bit 50 exiting a bit chamber 99 can move past an obstruction, such as a handle front portion 575 and/or a ratchet mechanism 60, or other obstruction. When removed, the bypass angle 925 provides a bypass clearance distance 199 which in some embodiments is the distance between a proximate surface 118 of the bit 50, which can be the portion of the bit closest to the potential obstruction to its movement and the potential obstruction when the bit is radially planar to the potential obstruction. Where a bypass clearance distance 199 is greater than zero the bit 50 can move without interference past the potential obstruction to fully exit the bit chamber 99.

FIG. 4 shows the handle front end 59 which can have a maximum handle front end radius 577 and a maximum handle front end diameter 578. A 1^{st} bypass angle 125 measured from the driver centerline axis 999 to the 1^{st} bit chamber axis 1000 can be used to orient the 1^{st} bit chamber 100 in relation to position the 1^{st} exit path 181 such that the 1^{st} proximate surface 18 of the 1^{st} bit 10 can be moved past the handle front end 59 and the ratchet mechanism 60 without interference.

FIG. 4 shows a 1^{st} handle clearance distance 203 measured between a 1^{st} proximate surface 18 of the 1^{st} bit 10 and the maximum handle front end radius 577 and/or maximum handle front end diameter 578.

FIG. 4 shows a ratchet mechanism 60 which can have a maximum ratchet radius 550 and a maximum ratchet diameter 560. The 1^{st} bypass angle 125 can be used to orient the 1^{st} bit chamber 100 in relation to position the 1^{st} exit path 181 such that the 1^{st} proximate surface 18 of the 1^{st} bit 10 can be moved past the ratchet mechanism 60 with a 1^{st} ratchet clearance distance 190. FIG. 4 shows the 1^{st} ratchet clearance distance 190 measured between the 1^{st} proximate surface 18 of the 1^{st} bit 10 and the maximum ratchet radius 550 and/or maximum ratchet diameter 560.

A handle bypass clearance 201 can also achieve the ratchet clearance distance 98 between the maximum ratchet radius 550 and the proximate surface 118 of a bit. In some embodiments, the ratchet clearance distance 98 can be in a range of 0.5 mm to 20 mm, or 1 mm to 10 mm, or 1 mm to 5 mm, such as 1.4 mm, 1.5 mm, 1.9 mm, 2 mm, 5 mm, or 10 mm. Each of the 1^{st} ratchet clearance distance 190, 2^{nd} ratchet clearance distance 290, 3^{rd} ratchet clearance distance 390, and 4^{th} ratchet clearance distance 490, can respectively have a value in a range of 0.5 mm to 20 mm, or 1 mm to 10 mm, or 1 mm to 5 mm, such as 2 mm, 3 mm, 4 mm, 5 mm, 10 mm, or 15 mm. Each of the respective ratchet clearance distances can be the same or different.

FIG. 4 also shows the 3^{rd} bit chamber 300 which can have the 3^{rd} bit chamber axis 3000, a 3^{rd} bit chamber inlet 310, a 3^{rd} bit chamber inlet diameter 311, a 3^{rd} bit chamber length 313 and a 3^{rd} bit chamber outlet 320. The 3^{rd} bit chamber 300 is shown storing the 3^{rd} bit 30 which can have a 3^{rd} bit tip 32, a 3^{rd} bit shank 34 and a 3^{rd} drive head 36. A 3^{rd} bit axis 3100 can be collinear with the 3^{rd} bit chamber axis 3000.

FIG. 4 illustrates the single motion removal step of the 3^{rd} bit 30 from a stored state 580 as shown in solid lines in FIG. 4 to an unstored 582, or a removed state, as shown in dashed lines in FIG. 4. The single motion removal step moves the 3^{rd} bit 30 along the 3^{rd} exit path 381, along the 3rd exit chute 368 and out of the 3^{rd} bit chamber 300 for use by the operator. In an embodiment, the exit path 180 can have an exit path centerline axis 1080 which can be collinear with the 3^{rd} bit chamber axis 3000 and the 3^{rd} bit axis 3100.

The 3^{rd} bypass angle 325 achieves a 3^{rd} exit path 381 for a 3^{rd} bit 30. In the embodiment of FIG. 4, the 3^{rd} bit chamber 300 can have a 3^{rd} bit chamber axis 3000 which can be at an angle with the driver centerline axis 999 and forming a bypass angle 925. The bypass angle 925 can be measured as the angle from the driver centerline axis 999 to the 3^{rd} bit chamber axis 3000. As shown in FIG. 4, the 3^{rd} bit axis 3100 can be collinear with the driver centerline axis 999 and the bypass angle 925 in this embodiment can also be equal to the angle measured from the driver centerline axis 999 to the 3^{rd} bit axis 3100.

The 3^{rd} bypass angle 325 can achieve the bypass clearance distance 199. A handle bypass clearance 201 can be the handle clearance distance 202 between the maximum handle front end radius 577 and the proximate surface 118 of the 3^{rd} bit 30.

The 3^{rd} bypass angle 325 measured from the driver centerline axis 999 to the 3^{rd} bit chamber axis 3000 can be used to orient the 3^{rd} bit chamber 300 in relation to position the 3^{rd} exit path 381 such that the 3^{rd} proximate surface 38 of the 3^{rd} bit 30 can be moved past the handle front end 59 and the ratchet mechanism 60 without interference.

FIG. 4 shows a 3^{rd} handle clearance distance 205 measured between a 3^{rd} proximate surface 38 of the 3^{rd} bit 30 and the maximum handle front end radius 577 and/or maximum handle front end diameter 578.

The 3^{rd} bypass angle 325 can be used to orient the 3^{rd} bit chamber 300 in relation to position the 3^{rd} exit path 381 such that the 3^{rd} proximate surface 38 of the 3^{rd} bit 30 can be moved past the ratchet mechanism 60 with a 3^{rd} ratchet clearance distance 390. FIG. 4 shows the 3^{rd} ratchet clearance distance 390 measured between the 3^{rd} proximate surface 38 of the 3^{rd} bit 30 and the maximum ratchet radius 550 and/or maximum ratchet diameter 560.

The FIG. 4 sectional view A-AA of the example embodiment of FIG. 1 taken coplanar through the 1^{st} bit chamber axis 1000 and the 3^{rd} bit chamber axis 3000, can be considered analogous and/or representative of a similar sectional view which can be taken by a plane through the 2^{nd} bit chamber axis 2000 and the 3^{rd} bit chamber axis 4000. Analogous features, bypass angles, clearances and configurations of components would be shown. In some embodiments, the features distributed radially about the longitudinal axis 998 and/or the driver centerline axis 999. This disclosure is intended to disclose such features of a section taken a plane through the 2^{nd} bit chamber axis 2000 and the 3^{rd} bit chamber axis 4000.

As shown in FIG. 5, in some embodiments, each bit chamber can have a bit retention component, such as 1^{st} bit grip 150, 2^{nd} bit grip 250, 3^{rd} bit grip 350 and 4^{th} bit grip 450. The bit retention component can prevent the bits from sliding out of the through holes in any orientation in which the fastener driver 1 can be held and/or oriented. Optionally, the bit retention component can be made of a viscoelastic material, such as a rubber grommet, or projections which reversibly engage with at least a portion of a bit 50.

FIG. 5 shows an exploded view of the handle 57. FIG. 5 shows the rear handle body 80 which can have one or more of the bit chamber 99, the front handle body 70 which can have one or more of the exit chute 68, the first bit retainer 135 which can have one or more of a bit grip 249, the second bit retainer 235 which can have one or more of a bit grip 249, and the handle grip 90.

FIG. 5 shows an embodiment in which the rear handle body 80 can have: the 1^{st} bit chamber 100 which can have the 1^{st} bit chamber axis 1000 and a 1^{st} bit chamber outlet diameter 121; the 2^{nd} bit chamber 200 which can have the 2^{nd} bit chamber axis 2000 and a 2^{nd} bit chamber outlet diameter 221; the 3^{rd} bit chamber 300 which can have the 3^{rd} bit chamber axis 3000 and a 3^{rd} bit chamber outlet diameter 321; and the 4^{th} bit chamber 400 which can have the 4^{th} bit chamber axis 4000 and a 4^{th} bit chamber outlet diameter 421.

FIG. 5 shows the bypass angle 925 for each respective bit chamber 99. Bypass angle 125 is shown measured between the driver centerline axis 999 and the 1^{st} bit chamber axis 1000. Bypass angle 225 is shown measured between the driver centerline axis 999 and the 2^{nd} bit chamber axis 2000. Bypass angle 325 is shown measured between the driver centerline axis 999 and the 3^{rd} bit chamber axis 3000. Bypass angle 425 is shown measured between the driver centerline axis 999 and the 4^{th} bit chamber axis 4000.

The front handle body is shown having a number of the exit chute 68, such as the exit chute 168, the exit chute 268 and the exit chute 368. The exit chute 468 is hidden in this perspective (see FIG. 3).

In some embodiments, the bit retainer 234 can have a number of the bit grip 249, such as in a range of 1 to 10 bit grips 249, for non-limiting example 1, 2, 3, 4, or more.

The 1^{st} bit retainer 135 is shown to have: a 1st bit grip 150 in which the 1^{st} bit 10 which has the 1^{st} bit axis 1100 and which can be reversibly maintained in a stored state 580; and a 4^{th} bit grip 450 in which the 4^{th} bit 40 which has the 4^{th} bit axis 1400 and which can be reversibly maintained in a stored state 580. The bypass angle 125 and the bypass angle 425 are shown.

The 2^{nd} bit retainer 235 is shown to have: a 2^{nd} bit grip 250 in which the 2^{nd} bit 20 which has the 2^{nd} bit axis 1200 and which can be reversibly maintained in a stored state 580; and a 3^{rd} bit grip 350 in which the 3^{rd} bit 30 which has the 3^{rd} bit axis 1300 and which can be reversibly maintained in a stored state 580. The bypass angle 225 and the bypass angle 325 are shown.

FIG. 5 also shows the handle grip 90, which can be optionally overmolded upon one or both of the rear handle body 80 and the front handle body 70. In an embodiment, the overmolded material can be a soft resilient material which can provide a spring force against the 1^{st} bit retainer 135 and the 2^{nd} bit retainer 235, to further apply pressure to the bits in addition to the imparted forces of the bit grips 249.

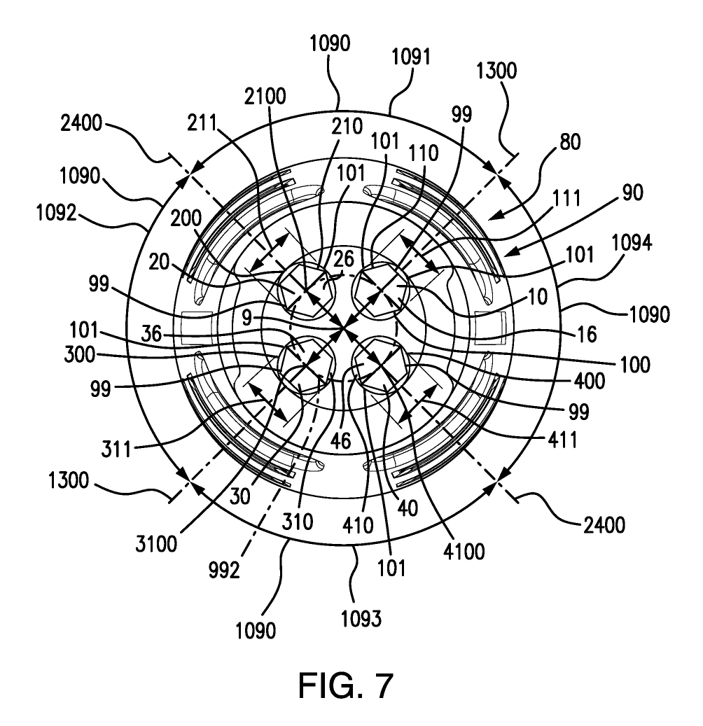

FIG. 5 shows and outlet radius 991 which can be measured as the radial distance between the driver centerline axis 999 and each bit chamber axis 99 at the plane of the 1^{st} outlet face 122 and/or the 2^{nd} outlet face 222 and/or 3^{rd} outlet face 322 and/or 4^{th} outlet face 422. In some embodiments, the outlet radius 991 can be in a range of from 5 mm to 50 mm, or 10 mm to 40 mm, or 15 mm to 35 mm, such as 25 mm, 30 mm, or 35 mm. An inlet radius 992 can be measured as the radial distance between the driver centerline axis 999 and each bit chamber axis 99 at the bit chamber inlet 101 (FIGS. 4 and 7). In some embodiments, the outlet radius 991 can be in a range of from 5 mm to 50 mm, or 3 mm to 20 mm, or 5 mm to 15 mm, such as 5 mm, 13 mm, or 16 mm.

The ratio of the outlet radius 991 to the inlet radius 992 can be in a range of from 1:1 to 10:1, or greater than 1:1 to 10:1, or 2:1 to 5:1, or 2:1 to 3:1, such as 2.0, or 2.4, or 2.6, or 3.0, or 4.0. In some embodiments, the ratio of the outlet radius 991 to the inlet radius 992 is greater than 1:1.

Optionally, the handle body 69 (FIG. 1) can be of a unibody (one piece) construction, or made from two or more components, such as rear handle body 80 (FIG. 5) and frond handle body 70 (FIG. 5). The body can be made of two or more components that create the passage and containment feature to hold bits. These components can be fit together and then can be overmolded to trap the components.

The example embodiment of FIG. 6 shows a fastener driver 1 which shows an embodiment of a ratcheting screwdriver 5 which has a bit 50 engaged, which can be a flat-drive head screwdriver bit. The ratchet mechanism 60 can be seen forward of the handle front end 59 of the front handle body 70.

FIG. 6 shows the ratchet mechanism 60 which can have the maximum ratchet diameter 560, as well as shows the front handle body 70 which can have the maximum handle front end diameter 578. In some embodiments, both the ratchet mechanism 60 and the front handle body 70 can overlap at least a portion of each bit chamber 99 and each bit 50 being stored in each bit chamber 99. The use of the bypass angle 925 (FIG. 4) provides a bypass clearance distance 199 achieving an unobstructed exit path 180 (FIGS. 4 and 8A-8D), to remove each stored bit 50 without obstruction by the ratchet mechanism 60 or the front handle body 70.

Each of the bits 50 are separated by a bit separation angle 1090. For example: a 1^{st} bit separation angle 1091 is shown between the 1^{st} bit chamber axis 1000 and the 2^{nd} bit chamber axis 2000; a 2^{nd} bit separation angle 1092 is shown between the 2^{nd} bit chamber axis 2000 and the 3^{rd} bit chamber axis 3000; a 3^{rd} bit separation angle 1093 is shown between the 3^{rd} bit chamber axis 3000 and the 4^{th} bit chamber axis 4000; and a 4^{th} bit separation angle 1094 is shown between the 4^{th} bit chamber axis 4000 and the 1^{st} bit chamber axis 1000.

In the embodiment of FIG. 6, a 1^{st} radial centerline axis 1300 is shown coplanar with 1st bit chamber axis 1000 and the 3^{rd} bit chamber axis 3000, as well as the 1^{st} bit axis 1100 and 3^{rd} bit axis 3100. A 2^{nd} radial centerline axis 2400 is shown coplanar with the 2^{nd} bit chamber axis 2000 and the 4^{th} bit chamber axis 4000, as well as the 2^{nd} bit axis 2100 and 4^{th} bit axis 4100.

FIG. 7 is a rear view of the fastening driver of FIG. 6 which can have four bit chambers 99 which each have a bit chamber inlet 101. For example, FIG. 7 shows: the 1^{st} bit chamber 100 having the 1^{st} chamber inlet 110 with the 1^{st} chamber inlet diameter 111; the 2^{nd} bit chamber 200 having the 2^{nd} chamber inlet 210 with the 2^{nd} second chamber inlet diameter 211; the 3^{rd} bit chamber 300 having the 3^{rd} chamber inlet 310 with the 3^{rd} chamber inlet diameter 311; and the 4^{th} bit chamber 400 having the 4^{th} chamber inlet 410 with the 4^{th} chamber inlet diameter 411.

As shown in FIG. 7: a 1^{st} bit 10 can be stored in the 1^{st} bit chamber 100 with 1^{st} drive head visible through the 1^{st} chamber inlet 110; a 2^{nd} bit 20 can be stored in the 2^{nd} bit chamber 200 with 2^{nd} drive head visible through the 2^{nd} chamber inlet 210; a 3^{rd} bit 30 can be stored in the 3^{rd} bit chamber 300 with 3^{rd} drive head visible through the 3^{rd} chamber inlet 310; and a 4^{th} bit 40 can be stored in the 4^{th} bit chamber 400 with 4^{th} drive head visible through the 4^{th} chamber inlet 410.

FIGS. 8A-8D show an embodiment of a single action push through storage process for a free bit 810 by which an operator moves a free bit 810 from an unstored state 582 to a stored state 580 in a bit chamber 99. In some embodiments, the movement of a free bit 810 into storage in a bit chamber 99 can displace a bit 50 previously stored in the same bit chamber 99 and into which the free bit 810 has been inserted.

In an embodiment, for example when an operator wants to change out bit 50 which is in a stored state 580 with free bit 810, the operator can do so by inserting bit 50 into the through hole containing free bit 810. In an embodiment, the process can begin with the bit 50 which can be inserted in the through hole from the rear of the handle towards the front. The bit 50 will push free bit 810 out of the hole (overcoming the forces imparted by the retention device). At the same time, the free bit 810 can be pushed out of the through hole, while bit 50 can be captured by the retention device. The result of this process is that the free bit 810 can be exposed enough to be easy grabbed by the fingers of the operator, and the bit 50 can be securely stored in the bit chamber 99.

In some embodiments, the action of placing the bit 50 into storage can cause the simultaneous release of another bit for use by an operator and can be accomplished by an operator in one motion and/or on action. In some embodiments, the bypass angle 925 can provide clearance for the movement during removal and/or release a bit past features on the front of the handle, the ratchet mechanism 50, the handle front portion 575, slide-on attachments, bolsters, or other features. In an embodiment, slide on accessories can be used with the driver bar 63, such as a collar, which can also be cleared by an existing bit through the use of a bypass angle.

FIG. 8A shows a 1^{st} bit 10 in a stored state 580 and a free bit 810 in an unstored state 582. FIG. 8A shows the cross sectional view of the embodiment of FIG. 5. In FIG. 8A, the 1^{st} bit 10 is shown in a stored state 580 in the 1^{st} bit chamber 100. The free bit 810 is shown in an unstored state 582 and can be aligned such that the first bit axis 1100, a free bit axis 8100 and the 1^{st} bit chamber axis 1000 can be collinear.

There is no requirement for collinearity of the free bit 810 in an unstored state 582 when its shaft is not at least in part within the bit chamber 99. Optionally, by mechanical design or by user preference, the bit chamber inlet 101 can receive a bit which is not collinear with the 1^{st} bit chamber axis 1100 and the 1^{st} bit chamber 100 can act to funnel the free bit 810 into the bit chamber 99 while being inserted to achieve a stored state 580 in which the free bit 810 has been stored in the bit chamber 99. FIG. 8A shows a free bit 810 being inserted through the 1^{st} chamber inlet 110.

FIG. 8B shows the free bit 810 being moved to impart a force upon the 1^{st} bit 10 when it is in a stored state 580. FIG. 8B shows the free bit tip 812 of free bit 810 imparting a motive force upon 1^{st} bit 10 by exerting a pressure force upon the 1^{st} drive head 16 of the 1^{st} bit 10. The force exerted from the free bit 810 in the unstored stated 582 to the 1⁴ bit 10 in a stored state 580 can start to move the 1^{st} bit 10 to transition out of the stored state 582.

FIG. 8C shows the free bit 810 being moved to achieve a stored state 580 and to release the 1^{st} bit 10 into an unstored state 582. FIG. 8C shows the 1^{st} bit 10 having moving along the 1^{st} exit path 181 into the unstored state 580 and the free bit 810 having been moved to achieve the stored state 580 in the 1^{st} bit chamber 100.

FIG. 8D shows the 1^{st} bit 10 in the unstored state 580 and the free bit 810 in a stored state 582. In FIG. 8D, the 1^{st} bit 10 has moved along the exit path 181 and achieved an unstored state 580 such that the 1^{st} bit 10 can be available for handling and use by an operator. At this point, FIG. 8D shows the free bit 810 having been reversibly stored in 1^{st} bit chamber 100.

In an embodiment, a bit 50 can be pushed through the bit chamber 99 in single action which both stores the bit 50 and optionally released a previously stored bit in the bit chamber 99. This single action push through process can be referred to as a push and pick design. In an embodiment, the bit 50 can be pushed through the bit chamber 99 in a direction from the rear end 9 toward the front driver end 8, or alternately in the opposite direction from the front driver end 8 to the rear end 9. In some embodiments, the fastener driver 1 can have a bit storage in which the ejected and/or released bit can leave the storage area in the same direction as the inserted bit.

In some embodiments, the fastener driver 1 can have single or multiple storage ports for bits, in which at least half of the storage area itself is a linear path. In other embodiments, the storage chamber and/or exit path can be curved, or multifaceted. Thus, a bit exiting from storage can move along an exit path with can be curved and/or not straight.

In an embodiment, removal of a stored bit 50 can require a push though force greater than 1 Kgf to dislodge a bit in a stored state 580 from a bit from a bit chamber 99. Herein the term “push through force” refers a pushing force imparted to a stored bit in an axial direction generally parallel to the bit centerline axis, or the axial force vector generally parallel to the bit axis of an oblique force upon the bit, which overcomes the forces maintaining the bit in a stored state and moves the bit to an unstored state. In an embodiment, the push through force can be a value in a range of 1 Kgf to 15 Kgf, or 1.5 Kgf to 6 Kgf, or 1.6 Kgf to 2.9 Kgf, or 2.0 to 3.0 Kgf, such as 1.6 Kgf, or 2.2 Kgf, or 2.4 Kgf, or 2.5 Kgf, or 3.5 Kgf, or 4.3 Kgf.

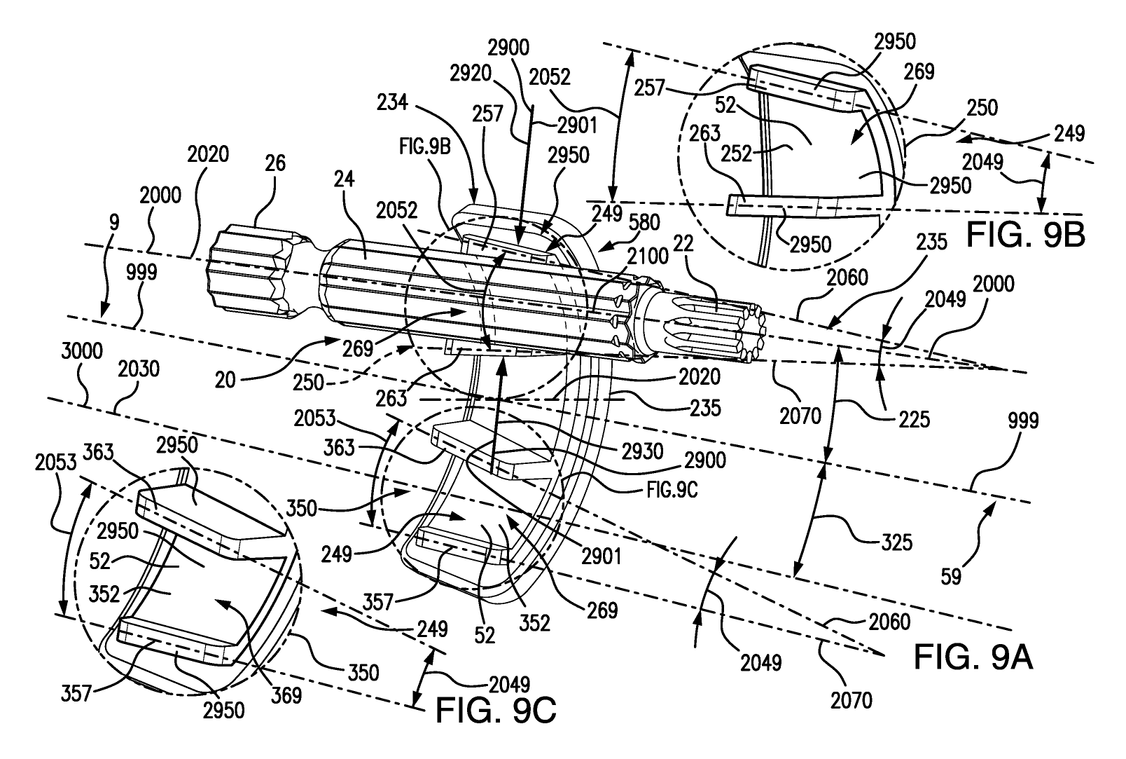

FIG. 9A is a front end perspective detail view of the bit retainer 234, which can for example be the 2^{nd} bit retainer 235 shown in FIG. 5. The 2^{nd} bit retainer 235 can have one or more of the bit grip 249, such as the 2^{nd} bit grip 250 and the 3^{rd} bit grip 350.

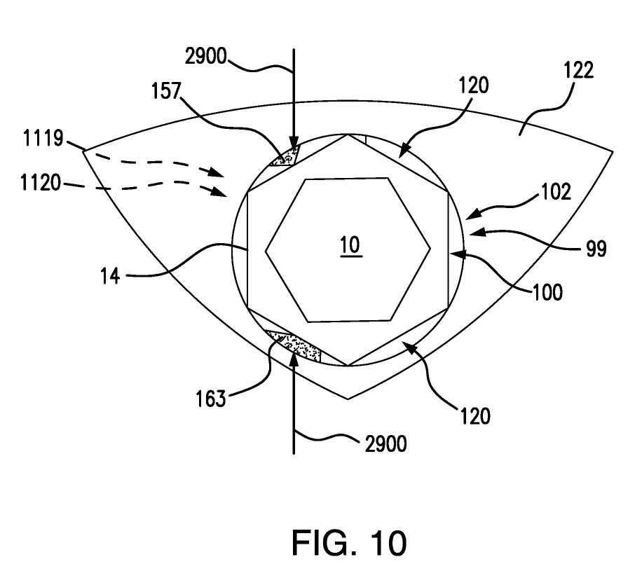

In an embodiment, the bit containment features can utilize a flexible tab geometry, having on or more projections which have frictional and/or pressure forces imparted against a stored bit to reversibly retain and store the bit in the bit chamber 99. Optionally, one or more of a magnetic source 1119 (FIG. 10) and/or one or more of a magnet 1120 can be used instead or in addition to the projections to apply an attractive magnetic force to a stored bit to reversibly retain the bit 50 in the bit chamber 99. Optionally, one or more of a magnetic source 1119 and/or one or more of a magnet 1120 can be used in, or along, as part of, or proximate to the bit chamber 99 and/or the bit retainer 234 and/or the bit grip 249. A number, of 1 . . . n, of the bit retainer 234 and/or a number of the bit grip 249 and/or an number of the magnet 1120 can be used in or associated with the storage chamber 99, in which n is large, such as 1, 2, 3, 4, 10 or 15.

The 2^{nd} bit retainer 235 can have a second bit grip 250 and a third bit grip 350. In an embodiment, the second bit grip 250 and the third bit grip 350 are configured as retention components in the 2^{nd} bit chamber 200 and 3^{rd} bit chamber 300 respectively. FIG. 9A shows the 2^{nd} bit chamber axis 2000 passing through the 2^{nd} bit channel 269 of the second bit grip 250. The 2^{nd} bit chamber axis can be at a 2^{nd} bypass angle 225 measured from the driver centerline axis 999 to the 2^{nd} bit retainer axis 2020, which can be collinear with 2^{nd} bit axis 2100, as well as collinear with the 2^{nd} bit chamber axis 2000.

The 3^{rd} bit chamber axis 3000 can be at a 3^{rd} bypass angle 325 measured from the driver centerline axis 999 to the 3^{rd} retainer centerline axis 2030.

FIG. 9A shows the 2^{nd} bit grip 250 retaining and maintaining the 2^{nd} bit 20 in a stored state 580. The 2^{nd} bit grip 250 exerts a retention force 2900 upon at least a portion of 2^{nd} bit 20, such as upon the 2^{nd} bit shank 24. The retention force 2900 can be one or more forces, such as one or more compressive forces and/or one or more frictional forces. As shown in FIG. 9A, the 2^{nd} bit grip 250 can have a 2^{nd} distal projection 257 which can exert a distal force in the direction of distal force arrow 2920 upon the 2^{nd} bit shank 24 and a 2^{nd} proximal projection 263 which can exert a proximal force in the direction of proximal force arrow 2930 upon the 2^{nd} bit shank 24.

FIG. 9A shows the second bit grip 250 retaining a second bit 20. In an embodiment, the 2^{nd} bit grip 250 can have a 2^{nd} distal projection 257 located distally from the 2^{nd} bit retainer axis 2020 and a 2^{nd} proximal projection 263 located proximally to the 2^{nd} bit retainer axis 2020. In some embodiments, the 2^{nd} distal projection 257 can exert a frictional force upon the 2^{nd} bit shank 24 as well as a compressive force 2901 in the direction of 2^{nd} distal force arrow 2920. The 2^{nd} proximal projection 263 can exert a frictional force upon the 2^{nd} bit shank 24 as well as a compressive force 2901 in the direction of the 3^{rd} proximal force arrow 2930.

The 2^{nd} bit grip 250 can be made of a grip material 2950 (FIGS. 9B and 9C) comprising a polymer which can have a shape memory and can resist permanent deformation such that when deformed by the entrance of a bit 50 the grip material 2950 exerts a force upon the 2^{nd} bit 20 sufficient to reversibly maintain the 2^{nd} bit 20 in a stored state 580 in a 2^{nd} grip channel 269. In some embodiments, the bit retainer can be made from elastomeric or non-elastomeric materials. In non-limiting example, the bit retainer can be made at least in part, or wholly, from polypropylene. Optionally, the bit retainer and/or the bit grip can be made in-pat or wholly from a thermoplastic non-elastomeric material and/or an elastomeric material and/or a material having a polymer, rubber, or plastic.

Optionally, the 2^{nd} distal projection 257 and the 2^{nd} proximal projection can be configured to have a grip angle 2049, such as a 2^{nd} grip angle 2052. The grip angle can range from zero degrees (0°) to 90° measured between a distal projection axis 2060 and a proximal projection axis 2070. In an embodiment, the grip angle have a value in a range of 0° to 45°, or 15° to 33°, or 5° to 10°, or 3° to 8°, or 2° to 5°, or 1° to 3°, such as 1°, or 5°, or 10°, or 15°, or 33°, or 45°, or 66°, or 75°.

FIG. 9B is a detail view of the 2^{nd} bit grip 250. FIG. 9B is a detail of the 2^{nd} bit grip 250 which can have a 2^{nd} bit channel 269 formed at least in part by one or more of the 2^{nd} distal projection 257 and the 2^{nd} proximal projection 263, as well as optionally a 2^{nd} a wall 52, such as a 2^{nd} outer wall 252. The 2^{nd} grip angle 2052 is also shown.

FIG. 9C is a detail view of a 3^{rd} bit grip 350 in a relaxed state when a bit is not being stored. FIG. 9C shows the 3^{rd} distal projection 357, the 3^{rd} bit channel 369, the 3^{rd} proximal projection 363 and the 3^{rd} outer wall 352. The 3^{rd} grip angle 2053 is also shown.

In some embodiments, a bit retaining device can be an insert which can be used to retain bits inside of a storage area, such as a bit chamber 99. Optionally, an insert can be used to retain the bit 50 within the bit chamber 99 without the need for elastomeric materials. In some embodiments, a bit retaining device can be captured and bound to the handle body 69 by means of an overmold. In an embodiment, the position of a bit within the handle of a bit driver can be maintained when the bit 50 is in a stored state 580. In some embodiments, a bit retaining device can be an insert which can use a flexible cantilever geometry to provide resistance to motion on a bit in storage. In some embodiments, a bit retaining device can be an insert adapted to hold a bit which can be in an orientation that is non parallel to the primary axis of the screwdriver.

In an embodiment, an entrapment feature, such as the bit retainer 234 and/or bit grip 249, can hold bits that are reversibly embedded within the handle body 69 of the handle 57 through a secondary molded component, such as the rear handle body 80.

As shown in FIGS. 9A-9D, bits can be removed from storage in a single motion. Each bit can be removed from a stored state 580 by moving it from its respective bit chamber 99 along an exit chute 68. For example, the 1^{st} bit 10 can be removed in a single motion by movement along 1^{st} exit chute 168, and 2^{nd} bit 20 can be removed in a single motion by movement along 2^{nd} exit chute 268.

In some embodiments, a bit retaining device can have a magnetic components used to retain the bit within the storage area.

FIG. 10 shows a detail of a 1^{st} bit chamber outlet 120 of the 1^{st} bit chamber 100 through which a 1^{st} bit 10 can be viewed in the stored state 580. FIG. 10 shows the 1^{st} distal projection 157 and the 1^{st} proximal projection 163 in contact with 2^{nd} bit shank 24 imparting retention force 2900.

Each of FIGS. 11A-11C is a detail view of a 1^{st} bit retainer 135 having a 1^{st} bit 10 maintained by a 1^{st} bit grip 150 in a stored state 580. FIG. 11A-11C also shows the release of the 4^{th} bit 40 from a stored state 580 (FIG. 11A) maintained by a 4^{th} bit grip 450 to an unstored state 582 (FIG. 11C) by action of moving a free bit 810 into a stored state 580 which pushes the 4^{th} bit 40 out of the 4^{th} bit grip 450.

FIG. 11A shows a 4^{th} bit 40 in a stored state 580 and a free bit 810 in an unstored state 582. The 4^{th} bit 40 can be held by 4^{th} bit grip 450 which maintains the 4^{th} bit 40 in a stored state 580. In this example, the free bit 810 is shown in an unstored state 582 and can be aligned such that the 4^{th} bit axis 4100, the free bit axis 8100 and the 4^{th} bit chamber axis 4100 are collinear.

FIG. 11B shows the free bit 810 being moved to impart a motive force upon the 4^{th} bit 40 by exerting a push through force upon the 4^{th} drive head 46 of the 4^{th} bit 40. The push through force exerted from the free bit 810 upon the 4^{th} bit 40 being held by the 4^{th} bit grip 450 can cause the 4^{th} bit 40 to move and be transitioned to a free and unstored state 580 and removal from the 4^{th} bit chamber 400. For example, FIG. 11B shows the free bit 810 being moved out from and away from the 4^{th} bit grip 450 and through the 4^{th} bit chamber outlet 420 to achieve an unstored state 582. FIG. 11B also shows the free bit 810 being moved into the 4^{th} bit grip 450 to achieve the stored state 580 in the 4^{th} bit chamber 400.

FIG. 11C shows the 4^{th} bit 40 free of the 4^{th} bit grip 450 having achieved an unstored state 582 in which the 4^{th} bit 40 has been released from the 4^{th} bit chamber 400. In FIG. 11C, the free bit 810 is shown as being held and/or retained by the 4^{th} bit grip 450 and as such reversibly stored in 4^{th} bit chamber 400.

This disclosure regards a fastener driver and its many aspects, features and elements. Such an apparatus can be dynamic in its use and operation. This disclosure is intended to encompass the equivalents, means, systems and methods of the use of the fastener driver and its many aspects consistent with the description and spirit of the apparatus, means, methods, functions and operations disclosed herein. Other embodiments and modifications will be recognized by one of ordinary skill in the art as being enabled by and within the scope of this disclosure.

The scope of this disclosure is to be broadly construed. The embodiments herein can be used together, separately, mixed or combined. It is intended that this disclosure disclose equivalents, means, systems and methods to achieve the devices, designs, operations, control systems, controls, activities, mechanical actions, dynamics and results disclosed herein. For each mechanical element or mechanism disclosed, it is intended that this disclosure also encompasses within the scope of its disclosure and teaches equivalents, means, systems and methods for practicing the many aspects, mechanisms and devices disclosed herein. The claims of this application are likewise to be broadly construed.

The description of the technology herein in its many and varied embodiments is merely exemplary in nature and, thus, variations that do not depart from the gist of the disclosure are intended to be within the scope of the claims and the disclosure herein. Such variations are not to be regarded as a departure from the spirit and scope of the disclosed technologies.

It will be appreciated that various modifications and changes can be made to the above described embodiments of the fastener driver as disclosed herein without departing from the spirit and the scope of the claims.

We claim:

1. A hand tool, comprising:
a handle body with a handle axis and a bit chamber having a bit chamber axis;
said bit chamber axis and said handle axis forming a bypass angle which has a value of greater than zero and less than 45°;
said bypass angle providing a bypass clearance distance between a bit which is passing through a bit chamber outlet and a portion of a fastener driver front section; and
wherein said bit chamber is adapted to store a first bit and configured such that the first bit moving out of storage from said bit chamber can move in the same general direction as a second bit moving into storage in said bit chamber.

2. The hand tool according to claim 1, wherein said bypass angle has a value in a range of from 1° to 33°.

3. The hand tool according to claim 1, wherein said bypass clearance distance allows the bit passing through a bit chamber outlet to move past a ratchet mechanism without physical contact with said ratchet mechanism.

4. The hand tool according to claim 1, further comprising a ratio of a bit chamber outlet radius to a bit chamber inlet radius which is greater than 1:1.

5. The hand tool according to claim 1, wherein said bit chamber axis is not a constant distance from said handle axis along at least a portion of said bit chamber length.

6. The hand tool according to claim 1, further comprising:
a first bit chamber having a first bit chamber axis which is not parallel with said handle axis; and
a second bit chamber having a second bit chamber axis which is not parallel with said handle axis.

7. The hand tool according to claim 1, wherein said bypass angle provides a handle clearance distance.

8. The hand tool according to claim 1, wherein said bypass angle provides a ratchet clearance distance.

9. The hand tool according to claim 1, further comprising an exit path having an exit path axis which is generally straight.

10. The hand tool according to claim 1, further comprising an exit path having an exit path boundary configured to have a clearance distance from said handle body.

11. The hand tool according to claim 1, further comprising an exit path having an exit path boundary configured to have a clearance distance from a ratchet mechanism.

12. The hand tool according to claim 1, further comprising an exit chute.

13. The hand tool according to claim 1, wherein the bit chamber comprises at least a portion of a bit grip.

14. A fastening device, comprising:
a bit chamber having a bit grip which has a bit channel;
said bit channel having a first projection and a second projection and configured to receive at least a portion of a bit;
said first projection configured for reversible contact with at least a portion of said bit when said at least a portion of the bit is in the bit channel;
said second projection configured for reversible contact with at least a portion of said bit when said at least a portion of the bit is in the bit channel; and
said bit grip adapted to reversibly retain a bit in a stored state.

15. The fastening device according to claim 14, wherein said bit grip is configured at least in part in a bit chamber.

16. The fastening device according to claim 14, further comprising a grip angle which is greater than zero degrees as measured between a first projection axis of the first projection and a second projection axis of the second projection.

17. The fastening device according to claim 14, wherein said bit grip comprises a polymer material.

18. The fastening device according to claim 14, wherein said bit grip comprises a magnet.

19. A bit retainer, comprising:
at least one bit grip having at least a distal projection and at least a proximal projection;
at least a portion of said distal projection and at least a portion of said said proximal projection forming at least a portion of a bit channel;
said bit channel adapted to reversibly receive at least a portion of a bit in a bit chamber; and
said bit grip adapted to reversibly retain the bit in the bit chamber.

20. The bit retainer of claim 19, further comprising:
a plurality of said bit grips.
